(19) United States
(12) Patent Application Publication
(10) Pub. No.: US 2006/0020925 A1
(43) Pub. Date: Jan. 26, 2006

(54) Analysing a multi stage process

(75) Inventors: Richard Taylor, Bristol (GB); Christopher Tofts, Bristol (GB)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Pakard Development Company, L.P.

(21) Appl. No.: 11/178,110

(22) Filed: Jul. 8, 2005

(30) Foreign Application Priority Data
Jul. 10, 2004 (GB) 0415469.6

(51) Int. Cl. G06F 9/44

(52) U.S. Cl. 717/127

(57) ABSTRACT

A computer program (10) analyses a specification for a process, by analysing automatically the specification of the process to identify a set of monitoring points, and determine automatically a cost of the monitoring. Measuring the cost can enable the cost to be reduced or the monitoring to be optimised for a given cost. The analysis can include identifying database accesses, and determine automatically how to reduce the amount of database accesses to improve database performance. It can also analyse automatically the specification to identify database accesses which involve database locking, and infer automatically how to reduce the scope and range of the locking, to improve database performance.

### FIELD OF THE INVENTION

The invention relates to methods of analysing specifications of multi stage processes, to optimise such processes, or for other purposes, to programs or systems arranged to carry out such analysis, to processes described by specifications subjected to such analysis, to templates for such processes, to services using such programs and to programs for analysing such processes in use.

### BACKGROUND TO THE INVENTION

Conventional commercial processes can typically be seen as a mixture of data processing stages or transactions on data accessed from data stores, and human actions such as a customer deciding which product to buy, and entering address and credit card details, or a human operator telephoning a supplier for example. Each data processing stage can involve a software program which queries a database. In a typical case, one stage could be concerned with taking customer orders, and could maintain a database of customer orders. A separate program could be responsible for issuing orders to suppliers, and could access the same database. There can be many stages in more complex processes. Problems can arise from errors in any program or in the data it needs. Despite many advances in software development, it is still impractical to test for correct operation in every set of circumstances. Also, in some cases, the performance of the process can be limited by the performance of the databases. There are a number of ways to address this, including providing upgraded hardware servers, or more servers, or by upgrading the database software for example.

Some of the issues and difficulties in designing and implementing mixed transactions are described in patent publication WO 0171621, such as coordination of computer resources necessary to implement even a single business process. In every large business, numerous incompatible computing platforms, operating systems, networking protocols, databases, and custom applications coexist. The various environments must be integrated in order to implement a new business process. In recent years, Message-Oriented-Middleware (MOM) products have been used to aid in the integration of disparate computing systems. Typically, such middleware products provide interfaces to applications by capturing, analysing, and exchanging information via “events.” This mechanism allows business analysts to integrate many diverse application platforms to work together. While middleware products allow business applications to communicate together, they do not ease the task of automating new business processes. Middleware products are often ineffective in reusing a business structure or business knowledge between applications. Instead, when such a business structure or knowledge must be reused, a new application must be created from scratch.

When structures or knowledge must be reused, many businesses have turned to object-oriented development environments to meet this need. Since reusability is an important element in the object-oriented paradigm, this approach should allow new applications to be developed by reusing objects created in earlier applications. Unfortunately, because of the technical nature of object creation, definition, and refinement, many of reusability advantages of the object-oriented paradigm are inaccessible to the typical business process analyst. The solution proposed in the above mentioned patent publication is a set of tools that allow the graphical definition of top-down workflow process models. Once defined, these models are completely useable enterprise applications that can be deployed in real-time without interrupting current business operations.

Another example shown in U.S. Pat. No. 6,473,748 discusses a rule based or expert system approach using middleware such as CORBA software objects and an object request broker. Problems associated with implementing business rules for an enterprise include the following. For example, the human reasoning behind a rule, or the “essence” of the rule, is often changed in transitioning from human-oriented user requirements to actual software code. Another potential problem is that the same logical rules may be implemented in several different software applications in an inconsistent manner. When rules are implemented as software code, the identification of specific business rules within a software application, or across several software applications, is often difficult or impossible. The solution proposed is separating business rules from application logic. This architecture effects the implementation of software business rules in a single location, for sharing across software applications as needed. Software business rules are created and maintained by business experts directly, rather than requiring programmers to translate the rules to software code. U.S. patent application 2003/0167194 shows a method of generating a process definition. It discusses workflow systems (i.e. process management packages) for controlling processes that are definable and governed by a series of policies and procedures, for example insurance claim processing, mortgage loan processing and engineering change orders. Workflow systems are based on procedure definitions that define which process activities must be performed and the sequence in which the activities must be performed. The procedure is defined using activity nodes connected via arcs, which represent activities of a process. Examples of activity node types are work nodes that typically perform, or initiate, a service and route nodes that are used to define the routing within the process. The activity nodes may incorporate rules that define entry conditions for the activity node and exit conditions that need to be checked after the activity node is completed. However, in practice a large number of aspects associated with businesses activities that are essential for a business solution escape a process-based formalisation. To counter this, the patent application proposes generating a process definition for execution by a process management system comprising a processor for generating a sequence of activities using information associated with messages exchanged between at least two business entities as part of a business process, wherein the sequence of activities correspond to the business process. It can involve monitoring messages exchanged between the at least two business entities.

U.S. Patent Application 20020049621 relating to decision dynamics, shows analysing a process in terms of the elements that are the drivers of the process. A process is evaluated in terms of one or more scheduling drivers and process drivers, the metrics around the drivers are measured and the measured values related to key performance indicators of the drivers and the overall process. The metrics of the drivers can be correlated to past performance to determine if the attributes of the drivers being measures should be changed. It is appropriate for evaluating the processes of a business organization where the processes can be defined by one of the following five process flows.

1) Research Process Flow (RPF). RPF represents independent activities which start and end exclusively of each other and do not trigger the starting of other activities. An example of this process flow is a market research firm which conducts research on several unrelated projects.

2) Research and Development Process Flow (R&DPF). R&DPF configures independent related groups of activities which start and end exclusively of other groups of activities, or loosely related to other groups of activities. Each group is comprised of activities related to each other by the finishing of one activity triggering the beginning of the next activity(s) within the group. An example of this process flow is a research and development laboratory of a drug company.

3) Development Process Flow (DPF). DPF configures groups of activities which start and end in relation to one another. The exact beginning or ending of a group of activities is frequently not known. Rather, there is a loose causality relationship that triggers the beginning and/or ending of related groups. All groups of activities are related by the purpose to perform work on a common entity. Optional triggering of potential activities may depend on other objects in the system, such as resources.

4) Project Process Flow (PPF). PPF configures individual groups of activities not related to other groups of activities within the system. Each group is comprised of activities which are related to each other because the finishing of one activity triggers the beginning of one or more activities within the group. An example is a law firm or consulting office working on several different legal or business problems for several different clients.

5) Operations and Maintenance Process Flow (O&MPF). O&MPF is an array of sequentially occurring activities with the completion of each activity triggering one or more activities. An example of this process flow is a manufacturing line for the manufacturing of an article in a factory. Nevertheless, difficulties remain in making processes reliable and efficient.

### SUMMARY OF THE INVENTION

It is an object of the invention to provide an improved program or an improved method or apparatus for the same.

A first aspect of the invention provides:

A computer program arranged to analyse a specification for a process, the process involving two or more stages and involving processing of stored data, the program being arranged to:
analyse automatically the specification of the process to identify a set of monitoring points and
determine automatically a cost of the monitoring.

Monitoring a process at its output or at intermediate points is usually necessary in order to control or refine the process or the resources needed for the process. However monitoring often involves a considerable cost, so there is great benefit in being able to measure this cost at the time of specifying the monitoring in the process design. Measuring the cost can enable the cost to be reduced or the monitoring to be optimised for a given cost.

Making the monitoring efficient is even harder in the common situation where coordination of different computer resources used at different stages of the process is necessary to implement even a single process. Often in practice there are numerous incompatible computing platforms, operating systems, networking protocols, databases, and custom applications coexisting. Implementing processes in environments with many such incompatibilities, can be made easier by embodiments of the invention.

The term “process” is used here as encompassing commercial or technical processes or any other type of process. Commercial processes can encompass internet based trading of products or services, and financial information processing and so on. Technical processes can encompass control of any kind of physical systems, such as air traffic control, manufacturing process control, communications network management and so on.

Additional features, for dependent claims, include rearranging the process to reduce the cost of monitoring. Another such feature is this identifying of monitoring points involving identifying branch points in the process. Another such feature is the rearranging involving reducing a number of the branch points. Another such feature is the determining of cost involving determining a cost of resources in processing and communicating monitor information to a central location. This can include the cost to the underlying system of including the monitors. Another such feature is the monitoring involving recording rates of choice and entry and exit times at branch points. Another such feature is the process having a combination of automated and non automated steps. Another such feature is rearranging automated steps in accordance with semantics preserving rules.

Another aspect of the invention provides a computer program arranged to analyse a specification for a process, the process involving two or more stages, and involving processing of stored data, the program being arranged to:
analyse automatically the specification of the process to identify monitoring steps, and
determine automatically how to optimise the monitoring. This can encompass identifying redundancies and identifying opportunities to reduce a frequency of monitoring steps, without significant impact on the effectiveness of the monitoring for the desired purpose.

Another aspect of the invention provides:

A computer program arranged to analyse a specification for a process, the process involving two or more stages, and involving processing of stored data, the program being arranged to:
analyse automatically the specification of the process to identify database accesses, and determine automatically how to reduce the amount of database accesses.

This is notable where the cost of database accesses is considerable, or where the time taken to access data is limiting performance of the process for example, or where the database is becoming overloaded by too many access requests.

Additional features, for dependent claims, include reducing an amount of accesses by rearranging process, or by optimising over a lifecycle of the data requested, or by identifying when a later data access can be brought forward and combined with an earlier data access. Further such features include identifying a probability of the later data access becoming redundant, and using that and the cost saved by the combining, to determine whether to implement the combining.

Another aspect of the invention provides

A computer program arranged to analyse a specification for a process, the process involving two or more stages, and involving processing of stored data, the program being arranged to:
analyse automatically the specification of the process to identify database accesses which involve database locking, and infer automatically how to reduce the scope and range of the locking.

As database locking can cause many queries to fail and therefore cause many retries, it can severely limit database performance. Hence there is great benefit in being able to optimise the locking to reduce it while still having enough to maintain consistency, and to ensure there is no sharing of data where this is unwanted. This is especially beneficial for large scale databases such as those distributed over many servers, or those distributed geographically.

Additional features, for dependent claims, include deriving dependency diagrams from the specification including any write dependencies on a read action, and the inference involving deriving data dependencies and reducing these dependencies. Further such features include rearranging the process to minimise the dependencies, and deriving a scope of locking from the dependencies. Further such features include the inference involving using associated declaration to reorder and combine queries. Further such features include the process having steps for control of a physical system. Further such features include analysing the process using information derived from the process in use. This can be useful to further check or optimise the process in use rather than that specified. This can be useful in various ways. For example, it may determine that users are entering data in different formats to those anticipated, or in different quantities, or that other aspects or the human interface are being used differently to the ways anticipated in the specification of the process.

Another aspect of the invention provides:

A process specification which has been created using (optimised or checked by) the analysis program set out above. This reflects that the commercial value may be greater in the output of the analysis program than the sale value of the analysis program itself.

Another aspect of the invention provides a method corresponding to the program.

Another aspect of the invention provides:

A process template for application to various processes, the template having been created using (optimised or checked by) the analysis program set out above. The template is intended to encompass higher level specifications such as process guidelines, process architectures, empty shell type structures, specifications with prompts for aiding completion, and many other forms.

Another aspect of the invention provides a method of offering a process analysis service using the program as set out above. This reflects that the services enabled by the use of the program could be more valuable than the sale value of the program itself.

Other advantages will be apparent to those skilled in the art. The abovementioned optional features may be combined together or combined with any aspect of the invention.

### BRIEF DESCRIPTION OF THE DRAWINGS

Embodiments will now be described by way of example with reference to the drawings in which:—

FIG. 1 shows a process design program according to an embodiment,

FIG. 2 shows a schematic view of a process having multiple stages and a number of data base accesses,

FIG. 3 shows a process design program according to another embodiment,

FIG. 4 shows steps relating to monitor points according to another embodiment, and

FIGS. 5 and 6 show steps relating to database accesses according to other embodiments.

### DETAILED DESCRIPTION

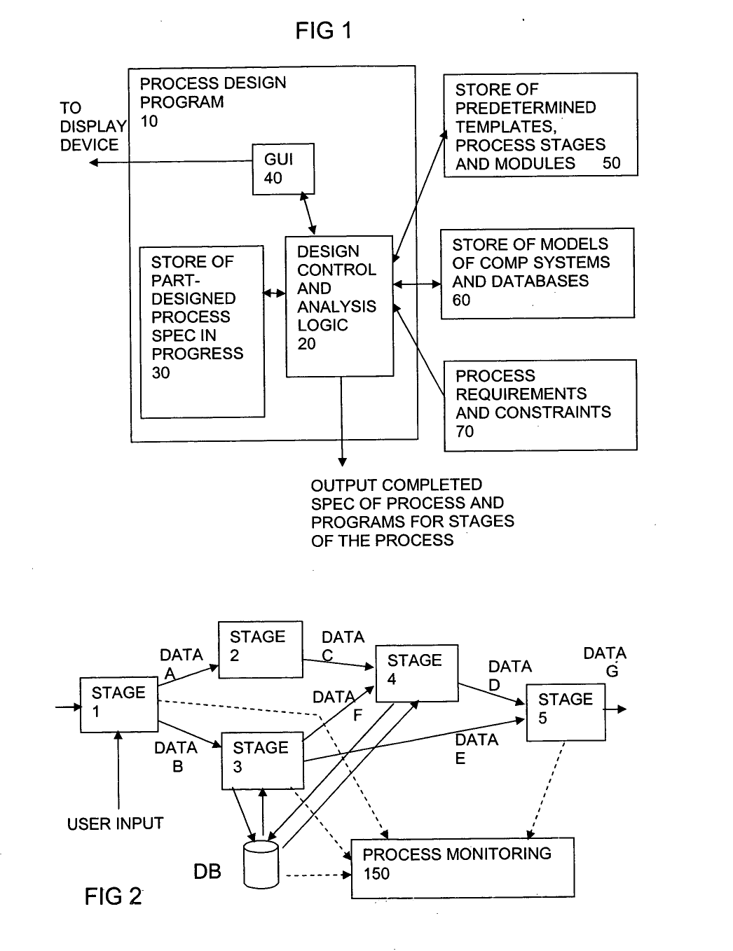

FIG. 1. Process Design Program

FIG. 1 shows in schematic form some of the principal elements of a process design program 10. It includes modules such as design control logic 20, a store 30 for storing a part-designed process specification, while it is in the process of being designed. The program interfaces to a store 50 of pre-determined process templates, pre-determined process stages, and pre-determined modules for building into processes. It also interfaces with a store 60 of models of underlying elements such as computer systems, communication systems and protocols, and data bases for example. The design control logic of the program also interfaces with process requirements and constraints 70. Typically the program interfaces with a human user through a GUI (graphical user interface) 40 or other interface such as a text only equivalent, which drives a display device.

The design control logic is arranged to follow instructions from the user to design the process, based on the process requirements and constraints. The design control logic is arranged to assist the user in a number of ways. Firstly it can aid the designer in producing a specification, by suggesting possible options which are available and consistent with the process requirements, and the part-completed specification. Secondly, the logic can analyse the specification or the part-completed specification, and check it for consistency, optimize the specification, to remove redundancies, to compress the specification, and to ensure interoperability with entities external to the process, such as underlying computer systems and communication systems, existing and new data bases, human interfaces for the process, and so on.

The logic can be arranged to check and optimise the part-complete specification. If there are any inconsistencies, the control logic can be used to flag a potential error to the user through the GUI. Optionally, the logic could be arranged to propose changes to correct the inconsistency, based on selecting from predetermined modules or stages, or other methods.

The control logic can also be arranged to look for non-optimal features in the process. These can include elements which are redundant, or which involve unnecessary coercion for example. Unnecessary coercion is defined as instances where data formats need to be converted unnecessarily, for example converting integers to long integers and back again for a logic test which makes no use of the long format. A common case involves data entry in a format which needs to be changed every time the data is used. If the data type could be changed to a more suitable format at the outset, many unnecessary conversion processing steps can be removed. An example is storing a date as a text string which must be re-parsed every time it is used.

The end result of the design process is an output from the design control logic which can include a completed specification of the process, and typically programs for stages of the process. The process design program can be implemented in any conventional software language running on conventional hardware such as workstations typically linked to file servers by a local area network. The format of the output will depend on the type of process and the environment for which it is designed. In the case of an example of an internet based product supply process, the specification could be in the form of a text document specifying programs, interfaces and data base accesses and human interfaces to customers and to staff of the organisation running the service. The text document could refer to programs or program modules written in conventional languages such as Java, weakly typed languages including C, or strongly typed functional languages such as “Miranda” or “Haskell” for example. Checking of the individual programs can be carried out using conventional techniques at compile time, including type inference techniques for example and some checks can be carried out at run-time.

FIG. 2. Example of Process

FIG. 2 shows a process having a number of stages. Each stage involves processing data of some kind. Stage 1 involves inputs from a preceding process and user input, and outputs on either one of two branches. Output data A in this example is fed to stage 2 for further processing, which produces data C. Data B is fed to stage 3 for further processing involving an access to a data base DB, and outputting either data E to stage 5 or, on another branch, outputting data F to stage 4. Stage 4 receives data C and carries out a data base access to data base DB and outputs data D. Stage 5 takes in data D and data E and outputs data G. A process monitoring element 150 is shown, coupled to monitoring points in the process. The monitoring points include the database, the stages where branching can take place, stages 1 and 3, and the output at stage 5. The monitoring can include rates of choice of each branch at branching points, and times of entry and exit of each execution of the process at various stages.

The different stages can involve computerised processing of data or manual or human processing of data, or a mixture. The data can represent almost anything, depending on the application of the process. One example might be processing an order for a product advertised on the internet. The user input could be an order for the product, together with a reference identifying the product, and an address and other details to enable payment and delivery. The various stages could make use of existing programs or procedures for arranging manufacture of the product or supply of parts for the product for example, or handling payment. The data base could be an inventory control data base, or a customer order data base for example, using conventional data base techniques. The data base could run on conventional servers, using a relational data base management system and query language such as SQL. The information input by the customer could include information such as address and postal code information. The data type of such a postal code could be considered as a compound data type including string types and integer types. This could be checked for consistency with the city field of the address for example, to ensure a correct postal code has been entered. It is much more efficient to catch errors such as incorrect postal codes at this early stage, rather than later in the process. The postal code information could be used at later stages in the process, for example in a program for arranging a delivery sequence or schedule. This could make use of existing programs for scheduling.

Such programs are likely to be written in a language incompatible with other programs in other stages. Nevertheless, it may be impractical to rewrite the functions of such existing programs, and therefore it is necessary to make use of them in the overall process. The designer of the process can use various methods to check the overall operation of the process to overcome problems caused by incompatibilities.

During operation of the process, it will be become clear which of many possible paths in the process are actually being used, or overused. The process monitoring element can be arranged to alter the process, or suggest alterations to a designer, depending on how the process is used in practice. For example, it may determine that users are entering data in different formats to those anticipated, or in different quantities, or that other aspects or the human interface are being used differently to the ways anticipated in the specification of the process. The monitoring element can look at actual data, rather than using the estimated data of the specification. Furthermore, this element can help identify paths in the process which are never used, and can propose that these be removed, or altered to make them more useful for example. The most used paths in the specification can optionally be re optimised, at the expense of less used paths. Potential limitations such as processing delays or processing power of stages can be assessed based on real life information, rather than the estimates in the specification.

An example involves monitoring how often exceptions are used. In some cases, exception handling code can expand to a disproportionate amount, e.g. 70%. But exception handling is typically the least well tested code, routine testing concentrates on the expected paths, not the exceptions. Hence if the most used exceptions can be identified, mainstream paths can be created so that they are no longer handled as exceptions. Reliability can be enhanced as a result.

The cost models store 130 is arranged to generate and store cost frames for a transaction from the medium that implements that transaction. This is to address the problem that costs of a complex transactional system may be difficult to specify where there are large numbers of cost types and cost amounts. If the media associated with a transaction is known, for example a data base access, a phone call, a fax transmission, an internet access, then a cost value can be assigned automatically based on typical costs for that medium, without the additional effort or complication of determining individual costs for such transactions or slightly varying transactions many times over.

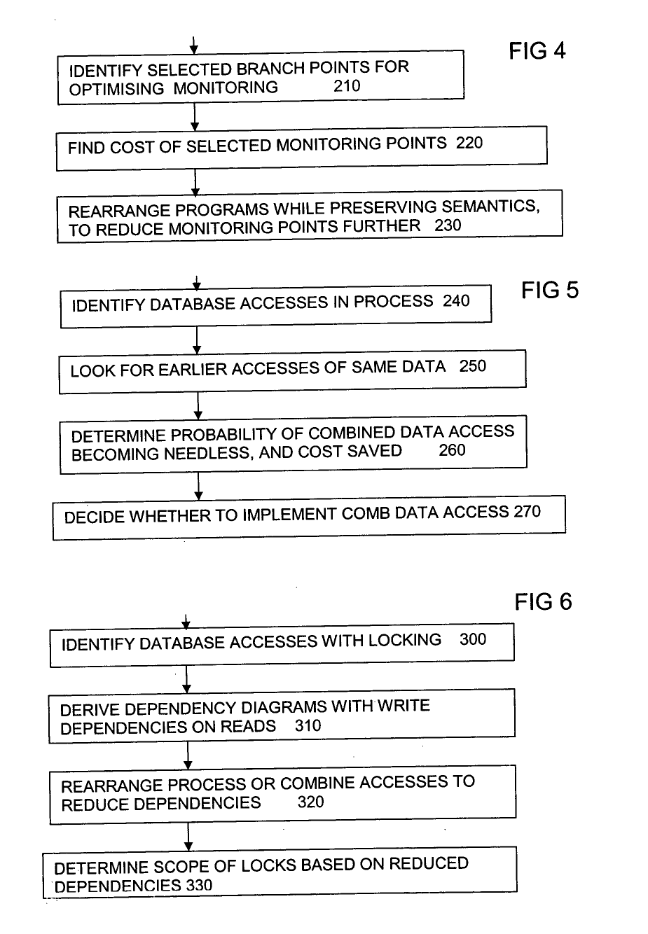

FIG. 4 Steps Relating to Monitor Points According to Another Embodiment

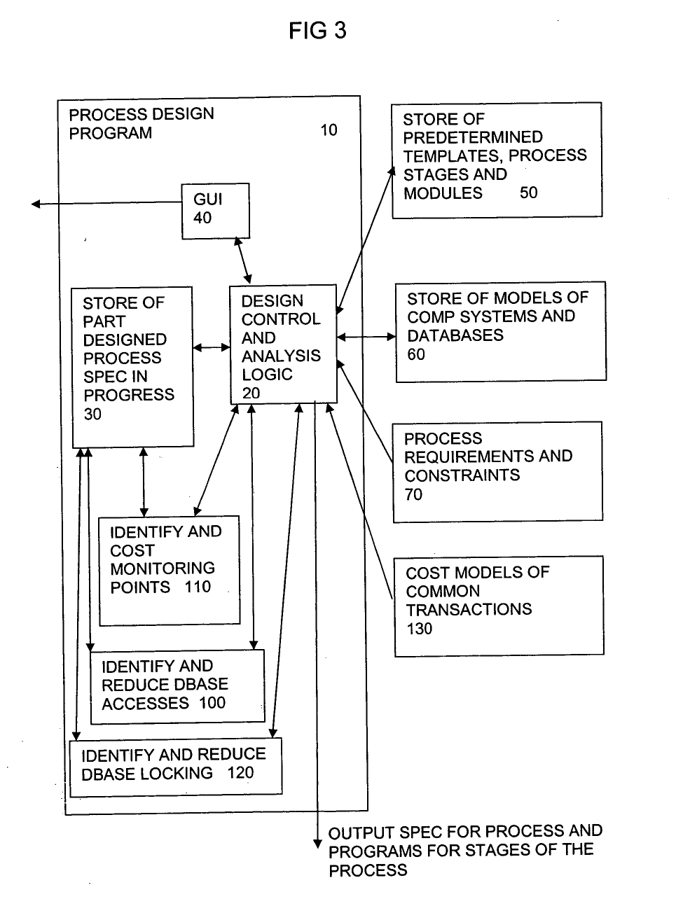

FIG. 4 shows some of the principal steps relating to monitor points when designing or optimising a process. The steps can be carried out by the monitoring element 110 of FIG. 3 or by other parts of the process design program. At step 210, selected branch points are identified as suitable monitoring points for monitoring the operation of the process in use. This can involve reviewing the specification or part complete specification to find key transition points. A typical specification can be divided into linear sections and branching points. The branching points represent the transitions. This step can involve automatic identification of the more significant branch points in terms of how much activity takes place or is likely to take place after the branch, or the likelihood of the branch being reached for example. This can be automated in various ways. For example, many complex systems aim to optimise to minimise or maximise an output which varies according to many different parameters. If there are too many possible Solutions for a linear programming approach, then other methods are used to search for favourable subsets of the possible solutions. Linear programming can be applied to the subset. The intermediate point before the subset is processed can be identified as a transition point. A typical monitoring of a process can involve recording rates of choice of each branch at each branching point, and times of entry and exit of linear sections. Optionally all branching points are monitored, but it is often more efficient to select the most useful, since there is usually a cost associated with each monitoring point.

At step 220 the cost of the selected monitoring points is determined in terms of operating costs such as processing costs and the cost of transmitting the monitoring results to a central location such as the element 150 of FIG. 2. This can use up processing power and transmission resources which might otherwise be available for the process, so the monitoring costs should be measured and minimised. At step 230, the automated parts of a process can be rearranged in accordance with semantics preserving rules. For example, redundancies in the monitoring can be identified and removed. A redundancy can occur if there is monitoring of stage 2, and stage 4 of FIG. 2. Since stage 2 feeds stage 4, and nowhere else, it is not necessary to monitor stage 2 separately since changes or faults in stage 2 will be picked up by the monitoring of stage 4. The rearrangements can be made to enable the monitoring points to be reduced again, particularly the more expensive ones, to optimise the cost of the monitoring compared to the benefit to be gained from each of the points. By maximising the scope of permitted rearrangements, the amount of simplification and cost reduction of the monitoring can be increased. Also, by optimising the monitoring at the process design level, it becomes easier to relate the monitoring points more closely to what is important in the process.

FIGS. 5 and 6, Steps Relating to Data Base Access and Locks According to Other Embodiments.

FIG. 5 shows some of the principal steps relating to data base accesses when designing or optimising a process. The steps can be carried out by the element 100 of FIG. 3 or by other parts of the process design program. At step 240 database accesses are identified automatically in the specification or the part complete specification. This enables determining points at which data can be extracted early from the database with minimal cost. The data can be passed between the elements of the process, rather than being obtained directly from the database. Minimising queries is a major issue for performance or cost, and optimisation is often worthwhile. In this case, the optimisation can take place with respect to a complete lifecycle of the data, not just optimising for individual queries.

At step 250 for each database access, a search is made for earlier accesses of the same data. The search can be made downstream to find later accesses of the same data as desired. IF the data gathering can be shifted to a single point by combining accesses, then interaction with the database can be minimised. At step 260, a further optional step is to determine a probability of the combined data access becoming needless. The cost benefit of the combined access is also determined. At step 270 a decision is made whether to implement the combined data access.

Notably this can help enable the design process to be carried out without the designer needing to be concerned about database optimisation. The designer can start with database accesses as needed and later allow automated optimisation.

FIG. 6 shows some of the principal steps relating to data base locking when designing or optimising a process. The steps can be carried out by the element 120 of FIG. 3 or by other parts of the process design program. At step 300, database accesses with database locking are first identified. At step 310, dependency diagrams are derived, the diagrams showing in particular any write dependencies on read operations. The process can then be rearranged and the database accesses combined or rearranged, or reordered, to reduce the dependencies at step 320. Finally at step 330, the scope of the locks can then be determined based on the reduced dependencies. In this way, the scope of the locks can be reduced, to improve database performance, without going so far as to cause errors from inconsistencies in the database.

Furthermore, by using associated declaration to do the reordering and combining of queries, a search can be made for optimal arrangements of queries given the locking that is in place.

An example will now be explained. A simple business process is as follows
take_customer_order
   lock database of goods in stock
   remove one item for customers order(failure based upon lack of goods has been left out for reasons of clarity)
   debit customer charge card
if customer can't pay add one item back to database
lock database of goods to be shipped add item number to goods to be shipped database
unlock database of goods to be shipped acknowledge to customer unlock database of goods in stock

A database only needs to be locked if it is being read from and or written to and a decision based upon the read and/or success of write is being made in this case. By locking the database, other processes can not access it. The process above locks the database for the complete process (as might be written by many programmers of business process) and this means that if there are many other identical (but with different customers) processes attempting to run then they will be blocked, despite the fact that no meaningful access of the database is being made. It can be rewritten (as per the process design program of the embodiment) so that it becomes
take_customer_order
   lock database of goods in stock
   remove one item for customers order
unlock database of goods in stock
debit customer charge card
if customer can't pay
   lock database of goods in stock
   add one item back to database unlock database of goods in stock lock database of goods to be shipped add item number to goods to be shipped database unlock database of goods to be shipped acknowledge to customer

There are now three points at which other processes can access the database, enabling significantly greater potential sharing of the database of goods in stock (especially when things like credit card authorization and shipping management can take in order of seconds compared with database lock and unlock in the order of micro seconds. If a dealer did not hand optimise this (as opposed to the machine based automation) then it would severely limit the number of accesses and therefore sales they could make.

Applications and Other Remarks

The advantages discussed above can apply to any process, including processes which involve a mixture of automated and non-automated steps, mixtures of data processing data base access steps and human inputs. In principle it can apply to processes for controlling physical systems, or for processes relating to service delivery, including services of providing value added information from raw data.

Examples of implementation of the design program or programs making up the process can include program objects that can be invoked via different programmatic paradigms e.g. API (application program interface, CLI (command line interface) and others, and can be invoked on a variety of different platforms including, but not limited to, a JAVA platform, an XML platform, a COM (common object model) platform and an ODBC (open database connectivity) platform for example. Embodiments of the present invention can be implemented as a computer program product that includes a computer program mechanism embedded in a computer readable storage medium. The program can take the form of instructions, rules, objects, look up tables, hardware descriptions, combinations of these and other forms. The computer program product could contain program modules. These program modules may be stored on a CD-ROM, magnetic disk storage product, or any other computer readable data or program storage product. The software modules in the computer program product may also be distributed electronically, via the Internet or otherwise, by transmission of a computer data signal (in which the software modules are embedded) on a carrier wave.

The advantages can also be obtained by offering a process analysis service using the program, which could prove more valuable than selling the program or a system. As the benefits will cascade down to users of the processes, in terms of more reliable and effective processes, another valuable aspect is a method of offering a service using a process created or optimised by an example of the above mentioned program. As has been described above, a computer program analyses a specification for a process, by analysing automatically the specification of the process to identify a set of monitoring points, and determine automatically a cost of the monitoring. Measuring the cost can enable the cost to be reduced or the monitoring to be optimised for a given cost. The analysis can include identifying database accesses, and determine automatically how to reduce the amount of database accesses to improve database performance. It can also analyse automatically the specification to identify database accesses which involve database locking, and infer automatically how to reduce the scope and range of the locking, to improve database performance. Other variations and applications can be conceived by those skilled in the art which are intended to be within the scope of the claims.

1. A computer program arranged to analyse a specification for a process, the process involving two or more stages, and involving processing of stored data, the program being arranged to:
analyse automatically the specification of the process to identify a set of monitoring points, and
determine automatically a cost of the monitoring.

2. The program of claim 1 arranged to determine how to rearrange the process according to the determined cost of the monitoring.

3. The program of claim 1, the identifying of monitor points involving identifying branch points in the process.

4. The program of claim 3, the rearranging involving reducing a number of the branch points.

5. The program of claim 1, wherein the determining of cost involves determining a cost of resources in processing and communicating monitor information to a central location.

6. The program of claim 1, wherein the monitoring involves recording rates of choice and entry and exit times at branch points in the process.

7. The program of claim 1, for a process having a combination of automated and non automated steps.

8. The program of claim 1, wherein the rearranging involves rearranging automated steps of the process in accordance with semantics preserving rules.

9. A computer program arranged to analyse a specification for a process, the process involving two or more stages, and involving processing of stored data, the program being arranged to:
analyse automatically the specification of the process to identify database accesses, and determine automatically how to reduce database accesses.

10. The program of claim 9, wherein determining how to reduce involves rearranging the process to reduce the number of database accesses by optimising over a lifecycle of the data requested.

11. The program of claim 9, wherein determining how to reduce i involves identifying when a later data access can be brought forward and combined with an earlier data access.

12. The program of claim 10, wherein the determining how to reduce involves identifying a probability of the later data access becoming redundant, and using that and the cost saved by the combining, to determine whether to implement the combining.

13. A computer program arranged to analyse a specification for a process, the process involving two or more stages, and involving processing of stored data, the program being arranged to:
analyse automatically the specification of the process to identify database accesses which involve database locking, and infer automatically how to reduce an amount of the locking.

14. The program of claim 13, wherein the inferring involves deriving dependency diagrams from the specification including any write dependencies on a read action.

15. The program of claim 13, wherein the inferring involves deriving data dependencies and reducing these dependencies.

16. The program of claim 13, wherein the inferring involves rearranging the process to minimise the dependencies, and deriving a reduced range and scope of locking from the dependencies.

17. The program of claim 13, wherein the inferring involves using associated declaration to reorder and combine queries.

18. The program of claim 13, for a process having steps for control of a physical system.

19. The program of claim 13, arranged to use information about the process in use. A computer program arranged to analyse a specification for a process, the process involving two or more stages, and involving processing of stored data, the program being arranged to:
analyse automatically the specification of the process to identify monitoring steps, and
determine automatically how to optimise the monitoring.

21. The program of claim 20, arranged to optimise by identifying redundancies in the monitoring.

22. The program of claim 20 arranged to identify opportunities to reduce a frequency of the monitoring steps.

23. A process specification which has been created using the analysis program of claim 20.

24. A method having the steps carried out by the program of claim 1.

25. A template for creating a specification for a process, the template comprising a partially complete specification created using the program set out claim 1.

26. A computer system having a processor arranged to run the program of claim 1.
